(19) United States
(12) Patent Application Publication
(10) Pub. No.: US 2026/0285696 A1
(43) Pub. Date: Sep. 24, 2026

(54) PROCESS FOR PRODUCING LOW-CARBON AMMONIA FROM NATURAL GAS

(71) Applicant: Publichnoe Aktsionernoe Obshchestvo "NOVATEK", Tarko-Sale (RU)

(72) Inventors: Aleksandr Iurevich UGLOV, Moscow (RU); Stanislav Aleksandrovich NIKULIN, Moscow (RU); Sergei Vladimirovich RUDENKO, Moscow (RU); Dmitrii Nikolaevich SEDAVNYKH, Moscow (RU); Vladimir Nikolaevich LEPSKII, Moscow (RU); Anna Aleksandrovna DUROVA, Moskovskaya obl., g. Dubna (RU); Aleksei Rafailevich AKHMETSHIN, Moscow (RU); Igor Aleksandrovich SHLIAPIN, Moscow (RU)

(73) Assignee: Publichnoe Aktsionernoe Obshchestvo "NOVATEK", Tarko-Sale (RU)

(21) Appl. No.: 19/476,738

(22) PCT Filed: Jan. 31, 2024
(86) PCT No.: PCT/RU2024/000022

§ 371 Date: Oct. 20, 2025

(30) Foreign Application Priority Data
Aug. 30, 2023 (RU) 2023122587

(51) Int. Cl. C01C 1/04; C01B 3/025; C01B 3/382

(52) U.S. Cl. CPC C01C 1/04; C01B 3/025; C01B 3/382; C01B 2203/0233; C01B 2203/0475; C01B 2203/068; C01B 2203/0827; C01B 2203/1241; C01B 2203/141; C01B 2203/142

(57) ABSTRACT

In technology for low-carbon ammonia production through natural gas conversion by primary and secondary reforming into a hydrogen- and nitrogen-containing synthesis gas, the resulting synthesis gas is subjected to carbon dioxide removal and then undergoes methanation, followed by high-pressure catalytic ammonia synthesis. The technical result is that the entire volume of the synthesis gas from the process line is used for the synthesis of ammonia and the process produces sufficient cold to support the ammonia recovery stage.

### TECHNICAL FIELD

The invention pertains to technologies for low-carbon ammonia production through natural gas conversion to hydrogen- and nitrogen-containing syngas followed by catalytic synthesis of ammonia at high pressure.

### BACKGROUND ART

A conventional method for producing ammonia from natural gas includes a stage, at which natural gas is converted into hydrogen- and nitrogen-containing syngas, and an ammonia synthesis stage, at which the syngas reacts at high pressure to produce ammonia.

At the conversion stage, natural gas is sent to treatment to remove undesirable impurities. The treated gas is then sent to a reforming stage to produce a converted gas containing mostly nitrogen, hydrogen, carbon monoxide (CO), and carbon dioxide (CO₂). The syngas is then sent to the CO conversion stage where carbon monoxide is oxidized to produce carbon dioxide (CO₂). After the carbon dioxide (CO₂) content is removed from the resulting gas mixture, the syngas is sent for methanation, the final purification stage.

At the ammonia synthesis stage, the syngas is compressed and sent to the synthesis stage to produce converted syngas containing mostly ammonia, nitrogen, and hydrogen. The resulting mixture is sent to the ammonia recovery stage.

The most common method for conventional ammonia production from natural gas is reforming, which includes two phases: steam pre-conversion (primary reforming) and secondary conversion of the resulting gas where a mixture of steam and oxygen or a mixture of steam, air, and oxygen is added (secondary reforming). Under this method, the heat required for the primary reforming reaction is generated by combusting some of the natural gas in a reforming furnace. The method also provides for the use of a fired heater to increase the temperature of process fluids and/or generate high-pressure steam for captive use in the ammonia plant.

The above furnaces and fired heaters that conventional ammonia plants comprise are a source of carbon dioxide (CO₂) emissions since they are fuelled by natural gas.

There exists a method for producing ammonia from natural gas, which includes compression, heating, and purifying of natural gas to remove sulfur compounds, two-stage catalytic conversion of methane under pressure, including steam conversion in the first stage and steam and air conversion in the second stage, using the heat from the gas converted in the second stage as well as from additional combustion of natural gas, purge and flash gases at a burner for the purposes of the first conversion stage of the conversion process, catalytic conversion of carbon oxide contained in the converted gas to produce a mixture of nitrogen and hydrogen, removal of carbon dioxide therefrom, removal of oxygen-containing compounds through methanation, compression of the purified mixture of nitrogen and hydrogen, ammonia synthesis in a closed loop, and separation of the resulting ammonia that is further distributed to the user, as well as recovery of the heat from the flues gases and their venting (RU 2445262 C1, publication date: Mar. 20, 2012).

The method drawback is the use of the heat from natural gas, which is combusted at the burner, thus generating carbon dioxide emissions.

A method for producing ammonia from natural gas, which is the closest to the proposed one, features low CO₂ emissions and consists in heating natural gas and steam in a furnace and transforming it in pre-reformers (primary reformers) and autothermal (secondary) reformers into syngas that contains H₂, CO, and CO₂; operating the autothermal reforming on oxygen-rich air or oxygen; converting the syngas in a conversion section and then removing CO₂ in a decarbonization section to produce deleted syngas; using a portion of the deleted syngas to fuel the furnace; treating the remaining deleted syngas in a methanator; adding the nitrogen exiting from an air separation section to the syngas fraction exiting the methanation section and sending the stream to an ammonia synthesis section where ammonia and purge gas are produced; extracting hydrogen from the purge gas and adding the hydrogen to the nitrogen and syngas stream before it is supplied to the ammonia synthesis section; adding the off-gas from the hydrogen extraction section to a portion of the deleted syngas, which is sent to the furnace as fuel; generating a stream of oxygen-rich air or oxygen in the air separation section for the autothermal reforming purposes (RU 2759379 C2, publication date: Nov. 12, 2021).

Since the method does not use natural gas as a fuel, carbon dioxide emissions are low.

The known method features the following drawbacks. A portion of syngas that could be sent to the ammonia synthesis stage to increase the market-grade product output is instead sent to combustion as fuel. Furthermore, the potential energy of pressure of the purge gas stream, which is also sent to combustion as fuel, is not utilized to produce cold, power. Furthermore, the process water is only supplied from external sources.

### ESSENCE OF THE INVENTION

A technical problem, which is solved with the proposed method, is improvement of overall low-carbon ammonia process efficiency.

A technical result, which is achieved through the proposed method, consists in enabling use of entire syngas volume in an ammonia synthesis line and self-sufficiency of an ammonia recovery stage in terms of cold.

The technical result is achieved with a method for producing ammonia that consists in heating the natural gas and steam and subjecting them to primary reforming, subjecting resulting converted gas to secondary reforming that operates on a mixture of steam, air, and oxygen, and then sending resulting converted gas to carbon oxide conversion, removing carbon dioxide from resulting syngas, methanating purified syngas, then synthesizing and recovering ammonia, which is exported as a finished product, while utilizing purge gas downstream the ammonia recovery as a fuel to increase temperature of the natural gas and steam; meanwhile according to the invention, after the methanation syngas is compressed and sent to the ammonia synthesis, downstream the ammonia recovery the purge gas pressure is reduced through expansion, the ammonia recovery uses a heating medium cooled as a result of the purge gas expansion, and ammonia condensed from the purge gas during expansion is exported as a finished product.

Besides recycling some of the purge gas to compression and then to the ammonia synthesis together with the syngas is also advisable.

Utilizing heat of the converted gas downstream the secondary reforming for the purposes of the primary reforming is also advisable.

Furthermore, condensate is extracted from flue gases generated during fuel combustion for heating up the natural gas and steam and then sent to the steam generation that utilizes heat of the converted gas downstream the secondary reforming, and resulting steam is used in the primary reforming and as part of the mixture of steam, air, and oxygen for the purposes of the secondary reforming.

Utilizing the purge gas downstream the ammonia recovery and pressure reduction as fuel to increase the temperature of the mixture of steam, air, and oxygen is also advisable.

The technical result is achieved by sending the entire volume of the syngas generated in the process line to the synthesis stage, while utilizing only the purge gas as a low-carbon fuel enabling CO2 emissions reduction. Because of high purge gas flow rate sent to combustion, downstream the ammonia recovery the purge gas pressure needs to be reduced through expansion, and cold generated during the expansion is utilized for the ammonia recovery purposes.

### LIST OF DRAWINGS

FIG. 1 shows the flow diagram of the proposed low-carbon ammonia production method.

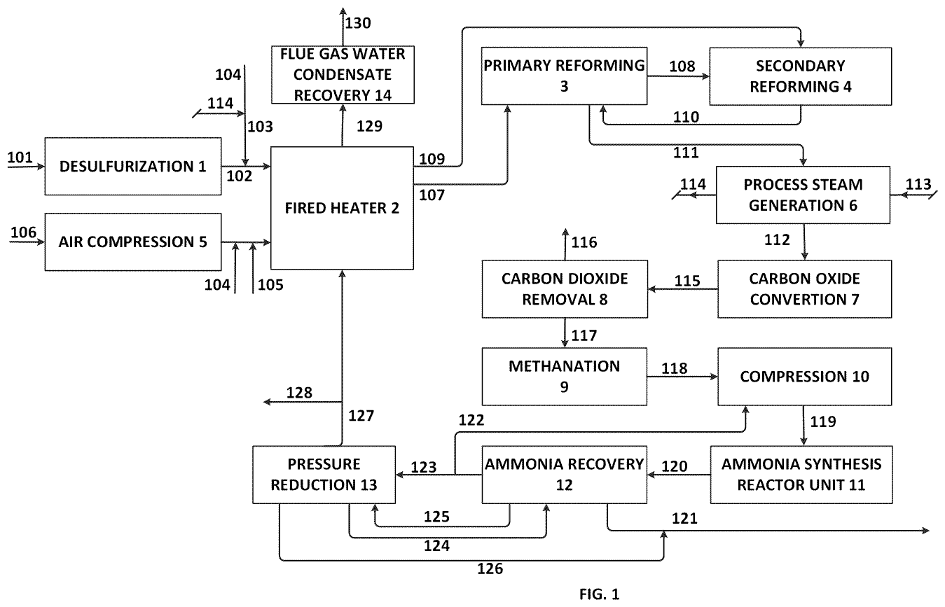

### EXAMPLES OF IMPLEMENTATION OF THE INVENTION

The method for producing ammonia from natural gas, referred to as Ammonia Decarbonized-2500, or AmDec-2500, is implemented as follows.

Natural gas feedstock 101 at approx. 5.0-7.5 MPa is suppled to desulfurization line 1 to produce gas that is free from undesirable impurities. Steam 103 is added to purified natural gas 102, which is then sent to fired heater 2. Steam 103 is a mixture of high-pressure steam 104 supplied from outside a process plant, and high-pressure steam 114 from process steam generation unit 6. Once heated to steam reforming reaction point temperature, mixture of steam and gas 107 is sent to reaction tubes of primary reforming reactor 3 where the process utilizes heat from converted gas 110 from secondary reforming stage 4. Converted gas 108 is then supplied to secondary reforming reactor 4.

Ambient air 106 is supplied to a process air compression line 5 where it is pressurized to approx. 5.0-7.0 MPa. Steam 104 and oxygen 105 are added to the compressed air and the stream is sent to fired heater 2. There is an option to add high-pressure steam 114 from process steam generation unit 6 to steam 104 (not shown in the diagram). Hot mixture 109 of steam, air, and oxygen is supplied to secondary reforming reactor 4 to produce converted gas mostly containing nitrogen, hydrogen, steam, carbon monoxide, and carbon dioxide.

The heat of exiting converted gas 110 is utilized to support reaction of primary reforming 3. Converted gas 111 from a tubular reactor is supplied to process steam generation unit 6 where stream heat is utilized to generate process steam 114 from flue gases 113 and for other purposes.

Converted gas stream 112 is supplied to carbon oxide conversion line 7 where catalytic conversion of carbon monoxide into carbon dioxide, promoted by steam, results in hydrogen generation. CO₂-containing syngas 115 resulting from such conversion is sent to carbon dioxide removal stage 8 based on amine refining. Carbon dioxide 116 removed from the syngas is sent for utilization.

CO₂-depleted syngas 117 is sent to methanator 9 where catalytic conversion of trace amounts of carbon dioxide remaining after carbon dioxide removal occurs. Syngas stream 118 is supplied to syngas compression unit 10 where the syngas is pressurized to 20-22 MPa. Compressed syngas 119 is sent to ammonia synthesis reactor unit 11.

Converted gas 120 from ammonia synthesis reactor unit 11 mostly containing nitrogen, hydrogen, and ammonia, is supplied to ammonia recovery unit 12. In ammonia recovery unit 12, converted gas 120 is cooled to below zero degrees Celsius, with the ammonia contained in converted gas 120 is partially condensed and exported as a product (stream 121). Converted gas 120 is cooled in ammonia recovery unit 12 using heating medium stream 124, which transfers the cold from pressure reducer 13 to ammonia recovery unit 12. Heating medium stream 125 heated up in ammonia recovery unit 12 is recycled to the pressure reducer for cooling.

The ammonia-depleted converted gas from ammonia recovery unit 12 is split into two streams of the same composition: recycle gas 122 is returned to compression unit 10 to be mixed with fresh syngas and further used as feedstock for the ammonia synthesis, while purge gas 123 is supplied to pressure reducer 13.

Pressure of purge gas 123 in pressure reducer 13 is reduced to approx. 0.2 MPa using a Joule-Thompson valve or an expander. As a result of the expansion, the gas cools down to below −50° C., with ammonia contained in purge gas 123 condensing and being exported as a product (stream 126). Cold generated in the pressure reducer is recovered using heating medium 125.

Resulting low-pressure purge gas 127 is intended to be used as fuel in fired heater 2. If necessary, a portion of purge gas (stream 128) is exported to be used as fuel in supporting processes.

Flue gases 129 from fired heater 2 at approx. 100-120° C. are supplied to flue gas water condensate recovery line 14. After the water condensate recovery, flue gases 130 comprised of nitrogen, residual water, and air impurities, are vented.

Because of the removal of carbon dioxide 116 for further utilization coupled with zero carbon dioxide content in the flue gases, CO₂ emissions are limited to less than 0.2 t/t (tonnes of CO₂ per tonne of ammonia product), which is equivalent to more than a 90 % CO₂ capture rate.

1: A method for producing ammonia from natural gas that comprises heating the natural gas and steam and subjecting them to primary reforming, subjecting resulting converted gas to secondary reforming that operates on a mixture of steam, air, and oxygen, and then sending resulting converted gas to carbon oxide conversion, removing carbon dioxide from resulting syngas, methanating purified syngas, then synthesizing and recovering ammonia, which is exported as a finished product, while utilizing purge gas downstream the ammonia recovery as a fuel to increase temperature of the natural gas and steam, wherein, after the methanation, the syngas is compressed and sent to the ammonia synthesis, downstream the ammonia recovery purge gas pressure is reduced through expansion, the ammonia recovery uses a heating medium cooled as a result of the purge gas expansion, and ammonia condensed from the purge gas during expansion is exported as a finished product.

2: The method according to claim 1, wherein some of the purge gas is recycled to compression and then to the ammonia synthesis together with the syngas.

3: The method according to claim 1, wherein heat of the converted gas downstream the secondary reforming is utilized for purposes of the primary reforming.

4: The method according to claim 1, wherein condensate is extracted from flue gases generated during fuel combustion for heating up the natural gas and steam and then sent to steam generation that utilizes heat of the converted gas downstream the secondary reforming, and resulting steam is used in the primary reforming and as part of the mixture of steam, air, and oxygen for purposes of the secondary reforming.

5: The method according to claim 1, wherein the purge gas downstream the ammonia recovery and pressure reduction is utilized as fuel to increase temperature of the mixture of steam, air, and oxygen.
